(19) United States
(12) Patent Application Publication
(10) Pub. No.: US 2013/0296468 A1
(43) Pub. Date: Nov. 7, 2013

(54) Flame-retardant polyamide compositions filled with ground glass

(71) Applicants: Jochen Endtner, Cologne (DE); Marcus Schafer, Pittsburgh, PA (US); Matthias Bienmuller, Krefeld (DE); Thorsten Bredemann, Frechen (DE); Robert Hubertus van Mullekom, Kruibeke (BE)

(72) Inventors: Jochen Endtner, Cologne (DE); Marcus Schafer, Pittsburgh, PA (US); Matthias Bienmuller, Krefeld (DE); Thorsten Bredemann, Frechen (DE); Robert Hubertus van Mullekom, Kruibeke (BE)

(73) Assignee: LANXESS Deutschland GmbH, Leverkusen (DE)

(21) Appl. No.: 13/932,084

(22) Filed: Jul. 1, 2013

Related U.S. Application Data
(63) Continuation of application No. 13/329,421, filed on Dec. 19, 2011, now abandoned.

(30) Foreign Application Priority Data
Dec. 23, 2010 (EP) 10196724.8

(51) Int. Cl. C08K 3/40; C08K 7/14; C08K 5/20; C08L 77/00; C08K 5/3492

(52) U.S. Cl. CPC C08K 3/40; C08L 77/00; C08K 5/34924; C08K 5/20; C08K 7/14
USPC 524/101

(57) ABSTRACT

The present invention relates to flame-retardant compositions based on a thermoplastic polyamide comprising non-fibrous and unfoamed ground glass with specific particle size distribution, geometry and size, and also to the production and the use of the compositions of the invention for producing products, preferably fibres, foils and mouldings of any type.

This application is a continuation of U.S. patent application Ser. No. 13/329,421 filed Dec. 19, 2011, with the same title, which claims the right of priority of European Patent Application No. 10196724.8 filed Dec. 23, 2010, the contents of which are hereby incorporated by reference in their entirety.

The present invention relates to flame-retardant compositions based on a thermoplastic polyamide comprising non-fibrous and unfoamed ground glass with specific particle size distribution, geometry and optionally size, and also to the production and the use of the compositions of the invention for producing products, preferably fibres, foils and mouldings of any type.

### BACKGROUND OF THE INVENTION

Most plastics are provided with auxiliaries, and also with fillers and reinforcing materials, the aim being to modify behaviour during work-up, processing and use. Fillers and reinforcing materials improve properties such as stiffness, strength, heat resistance, and dimensional stability, and reduce thermal expansion.

Fillers and reinforcing materials that are particularly important for compositions in engineering are those made of minerals or glass, in particular borosilicate glass or silicate glass, used in the form of glass fibres, hollow or filled glass beads, glass flakes, or else in the form of expanded or foamed glass.

DE 103 29 583 A1 and DE 103 34 875 A1 disclose materials which are intended for mouldings and which comprise inter alia polyamide as thermoplastic and ground glass as filler.

DE 10 2004 005 642 A1, DE 10 2004 017 350 A1 and DE 10 2004 038 162 A1 all concern food casings made of thermoplastic constituents inter alia based on (co)polyamide(s) with inter alia ground glass as inorganic particulate substance which can in particular be advantageously added in the external layer of the casing, where the d50 median grain size of the inorganic particles is greater than 10 μm, preferably in the range from 15 to 100 μm, particularly preferably in the range from 20 to 75 μm.

DE 10 2009 022 893 A1 moreover discloses power formulations with adsorbent particles based on polyesters or on polyamides to which ground glass can likewise be added as filler.

WO 2006/135840 A1 discloses thermally conductive components based on semiaromatic polyamides in which isotropic fillers, such as talc or glass flakes, can also be added in order to improve dimensional stability and warpage.

A well known disadvantage with use of fillers and reinforcing materials in combustible thermoplastics such as polyamides is however an adverse effect on fire performance, in particular on self-extinguishment performance, with the result that increased cost for use of flame retardants is generally necessary in order to achieve a particular fire classification to UL 94 or in the IEC60695-2-12 (GWFI) glow-wire test.

By way of example, WO 03/087226 A1 and US 2005/131105 describe compositions inter alia based on polyetherimides to which mixtures made of fibrous reinforcing materials and of non-fibrous inorganic fillers such as ground glass and/or glass flakes with diameter smaller than 1000 μm and with aspect ratio greater than 5 are added in order to optimize mechanical properties and dimensional stability, but without any resultant advantages in terms of flame retardancy.

EP 1 452 567 A1 describes flame-retardant resin compositions with a flame retardancy package and with inorganic fillers based on glass fibres and/or glass flakes. However, sufficient flame-retardant effect (e.g. UL 94 V-0) can be achieved here only with a complicated flame retardancy package requiring not only nitrogen-containing cyclic compounds but also PPO and/or PPS and phosphorous ester, and also an inorganic filler which must have been provided with a specific novolak-epoxy size in order to improve antidrip performance.

It was therefore an object of the present invention to provide, for thermoplastic polyamides, a filler and reinforcing material which has less adverse effect on self-extinguishment performance than conventional glass- or mineral-based fillers and reinforcing materials, for a comparable amount of flame retardant.

### SUMMARY OF THE INVENTION

Surprisingly, it has now been found that when non-fibrous and unfoamed, ground glass in the form described in more detail below is used in compositions based on polyamides, if the amount of flame retardant is comparable, there is less adverse effect on the fire performance of these compositions than would be the case with conventional glass- or mineral-based fillers and reinforcing materials or, respectively, that when the glass described in more detail below is used, even if the amount of, or concentration of, flame retardant is smaller, the fire performance that can be achieved is comparable with the performance that would be achieved with conventional glass- or mineral-based fillers and reinforcing materials.

The invention therefore provides compositions comprising
A) from 5 to 95% by weight, preferably from 20 to 90% by weight, particularly preferably from 30 to 80% by weight, of a thermoplastic,
C) from 5 to 80% by weight, preferably from 10 to 60% by weight, particularly preferably from 15 to 50% by weight, of a non-fibrous and unfoamed ground glass with d90 from 10 to 300 μm, preferably from 20 to 150 μm, particularly preferably from 35 to 80 μm.

The invention preferably provides compositions comprising
A) from 5 to 95% by weight, preferably from 20 to 90% by weight, particularly preferably from 30 to 80% by weight, of a thermoplastic polyamide,
B) from 0.01 to 40% by weight of melamine cyanurate and
C) from 5 to 80% by weight, preferably from 10 to 60% by weight, particularly preferably from 15 to 40% by weight, of a non-fibrous and unfoamed ground glass with d90 from 10 to 200 μm, preferably from 20 to 150 μm, particularly preferably from 35 to 80 μm.

For clarification, it should be noted that the scope of the present invention encompasses any desired combinations of the definitions and parameters listed below in general terms or in preferred ranges.

In one particularly preferred embodiment, the non-fibrous unfoamed ground glass has been sized with
C′) at least one aminoalkyltrialkoxysilane, preferably in amounts of from 0.01% by weight to 1,5% by weight, based on the amount of the non-fibrous and unfoamed ground glass.

In an alternative, particularly preferred embodiment, the compositions can also comprise D) from 0.01 to 60% by weight, preferably from 1 to 30% by weight, particularly preferably from 2 to 20% by weight, of at least one halogen-containing flame retardant or of one further halogen-free flame retardant which differs from the melamine cyanurate, in addition to components A), B), and C) or, respectively, A), B), C) and C′).

In another particularly preferred embodiment, the compositions can also comprise E) from 0.01 to 50% by weight, preferably from 1 to 25% by weight, very particularly preferably from 2 to 20% by weight, of at least one elastomer modifier, in addition to components A) to D) or instead of D).

In another particularly preferred embodiment, the compositions can also comprise F) from 0.01 to 5% by weight, very particularly preferably from 0.05 to 3% by weight, with particular preference from 0.1 to 2% by weight, of at least one lubricant and/or mould-release agent, in addition to components A) to E) or instead of D) and/or E).

In another particularly preferred embodiment, the compositions can also comprise component G) from 0.01 to 50% by weight, preferably from 1 to 30% by weight, very particularly preferably from 2 to 15% by weight, with very particular preference from 2 to 6% by weight, of at least one filler other than component C), in addition to components A) to F) or instead of D), E) and/or F).

In another particularly preferred embodiment, the compositions can also comprise H) from 0.01 to 20% by weight, preferably from 0.05 to 10% by weight, very particularly preferably from 0,1 to 5% by weight, in each case based on the entire composition, of at least one further additive in addition to components A) to G) or instead of components D), E), F) and/or G).

In one particularly preferred embodiment, the sum of the proportions of the components is always 100% by weight. It is also possible that the composition is composed only of A), B), and C) or preferably of A), B), C) and C′).

According to the invention, the compositions comprise at least one thermoplastic polyamide as component A).

According to Hans Domininghaus in “Die Kunststoffe und ihre Eigenschaften” [Plastics and their Properties], 5th edition (1998), _{P.} 14, thermoplastic polyamides are polyamides which soften when heated and can be moulded almost in any desired manner, and whose molecular chains have either no side branches or else have varying numbers of relatively short or relatively long side branches.

The polyamides preferred according to the invention can be produced by various processes and can be synthesized from a very wide variety of units, and in specific applications can be equipped with the following, alone or in combination: processing aids, stabilizers or else polymeric alloy partners, preferably elastomers, to give materials with specifically adjusted combinations of properties. Blends with proportions of other polymers, preferably of polyethylene, polypropylene, ABS are also suitable, and it is possible here, if appropriate, to use one or more compatibilisers. The properties of the polyamides can be improved via addition of elastomers, e.g. in relation to impact resistance, particularly of reinforced polyamides. The wide variety of possible combinations can give very many products with a very wide variety of properties.

Very many procedures have been disclosed for preparation of polyamides, using, as a function of the desired final product, different monomer units and, respectively, various chain regulators to set a desired molecular weight, or else monomers having reactive groups for any intended subsequent post-treatment.

The industrially relevant processes for production of polyamides mostly proceed by way of polycondensation in the melt. In this context the hydrolytic polymerization of lactams is also regarded as polycondensation.

Polyamides preferred for use as component A) are semicrystalline polyamides which can be produced by starting from diamines and dicarboxylic acids and/or lactams having at least 5 ring members or corresponding amino acids.

Starting materials that can be used are aliphatic and/or aromatic dicarboxylic acids, preferably adipic acid, 2,2,4- and 2,4,4-trimethyladipic acid, azelaic acid, sebacic acid, isophthalic acid, terephthalic acid, aliphatic and/or aromatic diamines, preferably tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids, preferably aminocaproic acid and, respectively, the corresponding lactams. Copolyamides composed of a plurality of the monomers mentioned are included.

Caprolactams are particularly preferably used, and ε-caprolactam is very particularly preferably used.

Other particularly suitable materials are most of the compounded materials based on PA6, on PA66 and on other aliphatic and/or aromatic polyamides and, respectively, copolyamides, where these have from 3 to 11 methylene groups for each polyamide group in the polymer chain.

Very particular preference is given to aliphatic polyamides, and very particular preference is in particular given to PA6 and PA66.

In one preferred embodiment, the compositions of the invention comprise not only the thermoplastic polyamide to be used according to the invention but at least one further thermoplastic polymer, particularly preferably at least one other polyamide.

Conventional additives, in particular mould-release agents, stabilizers and/or flow aids can be admixed in the melt with, or applied on the surface of, the polymers to be used in addition in one preferred embodiment alongside the thermoplastic polyamide.

Starting materials for the thermoplastic polyamides of component A) can come from a synthetic route, e.g. from petrochemical raw materials, and/or can come from renewable raw materials by way of chemical or biochemical processes.

The compositions of the invention comprise, as component B), from 0.01 to 40% by weight of melamine cyanurate. Melamine cyanurate is the reaction product of preferably equimolar amounts of melamine and cyanuric acid or isocyanuric acid. Among these materials are inter alia all of the product types available commercially. Examples here are inter alia Melapur® MC 25 and Melapur® MC50 (BASF, Ludwigshafen, Germany). The melamine cyanurate to be used according to the invention is preferably composed of particles with average particle diameters from 0.1 μm to 100 μm, particularly preferably from 0.1 μm to 30 μm, very particularly preferably from 0.1 μm to 7 μm, and can have been surface-treated or coated or sized with known compositions. Among these materials are preferably organic compounds which can have been applied in monomeric, oligomeric and/or polymeric form to the melamine cyanurate. Coating systems that can be used with particular preference are those based on silicon-containing compounds, in particular on organofunctional silanes or on organosiloxanes. It is equally possible to use coatings with inorganic components.

The compositions comprise, as component C), non-fibrous and unfoamed ground glass with a particle size distribution where d90 is from 10 to 200 μm, preferably from 20 to 150 μm, particularly preferably from 35 to 80 μm. It is preferable here to use non-fibrous and unfoamed ground glass where d10 is from 0.6 to 10 μm, preferably from 0.8 to 6 μm, particularly preferably from 1.0 to 5 μm. Very particular preference is given here to non-fibrous and unfoamed ground glass where d50 is from 3 to 50 μm, preferably from 5 to 40 μm, particularly preferably from 7 to 30 μm.

Procedure of Determination of Particle Size Distribution

In respect of the d10, d50 and d90 values and the determination thereof and significance thereof, reference may be made to Chemie Ingenieur Technik (72) pp. 273-276, 3/2000, Wiley-VCH Verlag GmbH, Weinheim, 2000, according to which
d10 is the particle size which is greater than that of 10% of the particles,
d50 is the particle size which is greater than that of 50% of the particles (median) and
d90 is the particle size which is greater than that of 90% of the particles.

The average particle size of this type of non-fibrous and unfoamed ground glass is preferably from 3 to 60 μm, with particular preference from 15 to 30 μm.

The data for particle size distribution and particle sizes here are based on what are known as surface-area-based particle sizes, in each case prior to incorporation into the thermoplastic moulding composition. The diameters of the surface areas of the respective glass particles are related here to the surface areas of imaginary spherical particles (spheres). This is achieved by using a particle size analyzer from Ankersmid, using the principle of laser obscuration (Eye Tech® comprising EyeTech® software and ACM-104 measurement cell, Ankersmid Lab, Oosterhout, Netherlands).

It is preferable that the shape of the non-fibrous and unfoamed ground glass is non-cylindrical and particulate and that its length:thickness ratio is smaller than 5, preferably smaller than 3, particularly preferably smaller than 2.

For purposes of delineation from the present invention, foamed glass, also often termed expanded glass, is a glass in which there are included gas bubbles, for example of air or carbon dioxide. Unlike in the unfoamed glass to be used according to the invention, the said inclusion of gas leads to a density reduction. The unfoamed and non-fibrous ground glass to be used according to the invention does not undergo any density reduction due to any possible gas inclusions.

For purposes of delineation from the present invention, fibrous glass is a glass with cylindrical or oval cross section and with a length:diameter ratio (LID ratio) greater than 5. The unfoamed and non-fibrous ground glass to be used as component B) is therefore also characterized in that it does not have the geometry which is typical of fibrous glass and which involves a cylindrical or oval cross section with a length:diameter ratio (LID ratio) greater than 5.

The unfoamed and non-fibrous ground glass to be used according to the invention is preferably obtained via grinding of glass in a mill, preferably a bead mill, and particularly preferably with subsequent sifting or sieving. Any of the geometric forms of solidified glass can be used as starting material.

Other preferred starting materials for the milling process to give non-fibrous and unfoamed ground glass to be used according to the invention are the glass wastes in particular arising as undesired by-product during the production of glass products and/or arising as offspec product. Among these are in particular waste glass, recycling glass and broken glass, as can in particular arise during the production of window glass or of bottle glass, or else during the production of glass-containing fillers and reinforcing materials in particular in the form of what are known as melt cakes. The glass can be coloured glass, but preference is given to uncoloured glass as starting material.

Glass that can be used as starting material for the milling process is in principle any of the types of glass as described by way of example in DIN 1259-1. Preference is given to soda-lime glass, float glass, quartz glass, lead crystal glass, borosilicate glass and E glass, and particular perference is given here to soda-lime glass, borosilicate glass and E glass and very particular preference is given here to E glass. In respect of physical data and constitution of E glass, reference may be made to http://wiki.r-g.de/index.php?title=Glasfasern. Non-fibrous and unfoamed ground E glass to be used with particular preference according to the invention therefore exhibits at least one of the features mentioned below:

| Properties of E glass | Unit | E glass |
|---|---|---|
| Density | g/cm³ at 20° C. | 2.6 |
| Tensile strength | MPa | 3400 |
| Tensile modulus of elasticity | GPa | 73 |
| Elongation at break | % | 3.5-4 |
| Coefficient of transverse contraction | | 0.18 |
| Electrical resistivity | Ω/cm/20° C. | 10¹⁵ |
| Coefficient of thermal expansion | 10⁻⁶ K⁻¹ | 5 |
| Dielectric constant | 10⁶ Hz | 5.8-6.7 |

| Chemical constitution | | |
|---|---|---|
| (guideline values) | Unit | Value |
| SiO₂ | % | 53-55 |
| Al₂O₃ | % | 14-15 |
| B₂O₃ | % | 6-8 |
| CaO | % | 17-22 |
| MgO | % | <5 |
| K₂O, Na₂O | % | <1 |
| Other oxides | % | about 1 |

Other types of glass equally particularly preferred for the production of the unfoamed and non-fibrous glass to be used according to the invention are those where the content of K₂O is smaller than or equal to 2% by weight, based on all of the components of the glass. The unfoamed and non-fibrous ground glass to he used according to the invention can by way of example be purchased from VitroMinerals, Covington, Ga., USA. It is supplied as what is known as CS Glass Powder in the following specifications: CS-325, CS-500 and CS-600. (See also www.glassfillers.com or Chris DeArmitt, Additives Feature, Mineral Fillers, COMPOUNDING WORLD, February 2011, pp. 28-38 or www.compoundingworld.com). Another alternative that can be used is MF7900 from Lanxess Deutschland GmbH, a non-fibrous and unfoamed ground glass based on E glass comprising about 0.1% by weight of triethoxy(3-aminopropyl)silane size C′) with d90 54 μm, d50 14 μm, d10 2.4 μm, and average particle size 21 μm, based in each case on the surface of the particle.

According to the invention, it is preferable that the unfoamed and non-fibrous ground glass to be used has been provided with a surface modification or size based on aminoalkyltrialkoxysilane.

In alternative or preferred embodiments, the unfoamed and non-fibrous ground glass can have been provided with additional surface modification or size based on silane or on siloxane, preferably using glycidyl-, carboxy-, alkenyl-, acryloxyalkyl- and/or methacryloxyalkyl-functionalized trialkoxysilanes, or using aqueous hydrolysates of these, or else a combination thereof.

Very particular preference is given to the following as C′): surface modifications using aminoalkyltrialkoxysilanes, in particular aminopropyltrimethoxysilane, aminobutyltrimethoxysilane, aminopropyltriethoxysilane, aminobutyltriethoxysilane, or using aqueous hydrolysates of these, where in particular very particular preference is given to aminopropyltriethoxysilane.

The amounts used of the aminoalkyltrialkoxysilanes of component C′) for surface coating, based on the unfoamed and non-fibrous ground glass C), are from 0.01% by weight to 1.5% by weight, preferably from 0.05% by weight to 1.0% by weight and particularly preferably from 0.1% by weight to 0.5% by weight.

The starting glass for the milling process can have been pretreated with surface modification or size. Equally, the unfoamed and non-fibrous ground glass to be used according to the invention can be treated with surface modification or size after the milling process.

The d90 or d50 or d10, or average particle size, of the unfoamed and non-fibrous ground glass to be used according to the invention can, by virtue of the processing to give the composition of the invention or to give the mouldings made of the composition of the invention, or within the moulding, be smaller than that of the ground particles originally used.

In one preferred embodiment, the compositions of the invention can comprise, as component D), at least one halogen-containing flame retardant or one halogen-free flame retardant alongside component B) and different from component B). Flame retardants that can be used are phosphorus-containing flame retardants selected from the groups of the mono- and oligomeric phosphoric and phosphonic esters, phosphonate amines, phosphonates, phosphinates, and particularly preferably metal dialkylphosphinates, in particular aluminum tris[dialkylphosphinates] and zinc bis[dialkylphosphinates], phosphites, hypophosphites, phosphine oxides and phosphazenes. Preference is given here to metal dialkylphospinates, and very particular preference is given here to aluminum tris[dialkylphosphinate] and zinc bis [dialkylphosphinate].

It is preferable to use nitrogen-containing flame retardants individually or in a mixture. Particular mention may be made of melamine oxalate, melamine phosphate prim., melamine phosphate sec. and melamine pyrophosphate sec., reaction products of melamine with condensed phosphoric acids and reaction products of condensates of melamine with phosphoric acid or with condensed phosphoric acids, in particular melamine polyphosphate, and also the reaction products of melamine and polyphosphoric acid with basic aluminum compounds, with basic magnesium compounds and/or with basic zinc compounds, and also melamine cyanurate and amine neopentyl glycol borate. The following are equally suitable: guanidine salts, such as guanidine carbonate, guanidine cyanurate prim., guanidine phosphate prim., guanidine phosphate sec., guanidine sulphate prim., guanidine sulphate sec., guanidine pentaerythrityl borate, guanidine neopentyl glycol borate, urea phosphate, and urea cyanurate. It is also possible to use condensates of melamine, in particular melem, melam, melon, or compounds of this type with higher level of condensation, and reaction products of these with condensed phosphoric acids. The following are equally suitable: tris(hydroxyethyl) isocyanurate and reaction products thereof with carboxylic acids, benzoguanamine and its adducts and its salts, and its products substituted on nitrogen, and also adducts and salts of these. Other nitrogen-containing components that can be used are allantoin compounds, and salts of these with phosphoric acid, boric acid or pyrophosphoric acid, and also glycol urils and salts of these.

It is also possible to use inorganic nitrogen-containing compounds, preferably ammonium salts, in particular ammonium polyphosphate.

Particularly preferred nitrogen-containing flame retardant in addition to component B) melamine cyanurate is melamine polyphosphate.

Halogen-containing flame retardants that can be used are commercially available organic halogen compounds with synergists individually or in a mixture. Preferred particular mention may be made here of the following brominated and chlorinated compounds: ethylene-1,2-bistetrabromophthalimide, epoxidized tetrabromobisphenol A resin, tetrabromobisphenol A oligocarbonate, tetrachlorobisphenol A oligocarbonate, pentabromopolyacrylate, brominated polystyrene, and bis(pentabroinophenylpethane. Examples of suitable synergists are antimony compounds, in particular sodium antimonate, antimony trioxide and antimony pentoxide.

It is also possible to use other flame retardant synergists or flame retardants not specifically mentioned here. Among these are purely inorganic phosphorus compounds, in particular red phosphorus or boron phosphate hydrate. It is moreover also possible to use salts of aliphatic and of aromatic sulphonic acids, and to use mineral flame retardant additives, such as aluminum hydroxide and/or magnesium hydroxide, and Ca-Mg carbonate hydrates (e.g. DE-A 4 236 122). It is moreover possible to use flame retardant synergists from the group of the oxygen-, nitrogen- or sulphur-containing metal compounds, preferably zinc oxide, zinc borate, zinc stannate, zinc hydroxystannate, zinc sulphide, molybdenum oxide, titanium dioxide, magnesium oxide, magnesium carbonate, calcium carbonate, calcium oxide, titanium nitride, boron nitride, magnesium nitride, zinc nitride, zinc phosphate, calcium phosphate, calcium borate, magnesium borate and mixtures of these.

Other preferred suitable flame retardant additives are carbon-forming materials, particularly preferably phenol-formaldehyde resins, polycarbonates, polyimides, polysulphones, polyether sulphones and polyether ketones, and also antidrip agents, in particular tetrafluoroethylene polymers.

The flame retardants can be added in pure form, or else by way of masterbatches or compactates.

The elastomer modifiers to be used as component E) in one preferred embodiment of the compositions of the invention encompass inter alia one or more graft polymers of
E.1 from 5 to 95% by weight, preferably from 30 to 90% by weight, of at least one vinyl monomer
E.2 from 95 to 5% by weight, preferably from 70 to 10% by weight, of one or more graft bases with glass transition temperatures <10° C., preferably <0° C., particularly preferably <−20° C.

The median particle size (d50) of the graft base E.2 is generally from 0.05 to 10 μm, preferably from 0.1 to 5 μm, particularly preferably from 0.2 to 1 μm.

Monomers E.1 are preferably mixtures of
E.1.1 from 50 to 99% by weight of vinylaromatics and/or ring-substituted vinylaromatics, in particular styrene, α-methyl styrene, p-methyl styrene, p-chlorostyrene, and/or (C1-C8)-alkyl methacrylates, in particular methyl methacrylate, ethyl methacrylate and

E.1.2 from 1 to 50% by weight of vinyl cyanides, in particular unsaturated nitriles, such as acrylonitrile and methacrylonitrile, and/or (C1-C8)-alkyl(meth)acrylate, in particular methyl methacrylate, glycidyl methacrylate, n-butyl acrylate, tert-butyl acrylate, and/or derivatives, in particular anhydrides and imides, of unsaturated carboxylic acids, in particular maleic anhydride and N-phenylmaleimide.

Preferred monomers E.1.1 have been selected from at least one of the monomers styrene, α-methylstyrene and methyl methacrylate, and preferred monomers E.1.2 have been selected from at least one of the monomers acrylonitrile, maleic anhydride, glycidyl methacrylate and methyl methacrylate.

Particularly preferred monomers are E.1,1 styrene and E.1.2 acrylonitrile.

Examples of graft bases E.2 suitable for the graft polymers to be used in the elastomer modifiers are diene rubbers, EPDM rubbers, i.e. rubbers based on ethylene/propylene and if approriate on diene, and also acrylate rubbers, polyurethane rubbers, silicone rubbers, chloroprene rubbers and ethylene/vinyl acetate rubbers. EPDM means ethylene-propylene-diene rubber.

Preferred graft bases E,2 are diene rubberes, in particular based on butadiene, isoprene, etc., or are a mixture of diene rubbers, or are copolymers of diene rubbers or of a mixture of these with other copolymerizable monomers, in particular according to E.1.1 and E.1.2, with the proviso that the glass transition temperature of E.2 is <10° C., preferably <0° C., particularly preferably <−10° C.

Particularly preferred graft bases E.2 are ABS polymers (emulsion ABS, bulk ABS and suspension ABS), where ABS means acrylonitrile-butadiene-styrene, examples being those described in DE-A 2 035 390 (=U.S. Pat. No. 3,644,574) or in DE-A 2 248 242 (=GB-A 1 409 275) or in Ullmann, Enzyklopadie der Technischen Chemie [Encyclopaedia of Industrial Chemistry], Vol 19 (1980), pp. 280 ff. The gel content of the graft base E.2 is preferably at least 30% by weight, particularly preferably at least 40% by weight (measured in toluene).

The elastomer modifiers or graft polymers E) are produced via free-radical polymerization, e.g. via emulsion, suspension, solution or bulk polymerization, preferably via emulsion or bulk polymerization.

Other particularly suitable graft rubbers are ABS polymers which are produced via redox initiation using an initiator system composed of organic hydroperoxide and ascorbic acid according to U.S. Pat. No. 4,937,285.

Because it is known that the graft monomers are not necessarily entirely grafted onto the graft base during the grafting reaction, products which are obtained via (co)polymerization of the graft monomers in the presence of the graft base and are produced concomitantly during the work-up are also graft polymers according to the invention.

Equally suitable acrylate rubbers are based on graft bases E.2 which are preferably polymers composed of alkyl acrylates, if appropriate with up to 40% by weight, based on E.2, of other polymerizable, ethylenically unsaturated monomers. Among the preferred polymerizable acrylic esters are C1-C8-alkyl esters, preferably methyl, ethyl, butyl, n-octyl and 2-ethylhexyl esters; haloalkyl esters, preferably halo-C1-C8-alkyl esters, such as chloroethyl acrylate, glycidyl esters, and also mixtures of the said monomers. Particular preference is given here to graft polymers having butyl acrylate as core and methyl methacrylates as shell, in particular Paraloid® EXL2300, from Dow Coming Corporation, Midland Mich., USA.

For crosslinking, monomers having more than one polymerizable double bond can be copolymerized. Preferred examples of crosslinking monomers are esters of unsaturated monocarboxylic acids having from 3 to 8 carbon atoms and of unsaturated monohydric alcohols having from 3 to 12 carbon atoms, or of saturated polyols having from 2 to 4 OH groups and from 2 to 20 carbon atoms, preferably ethylene glycol dimethacrylate, allyl methacrylate; polyunsaturated heterocyclic compounds, preferably trivinyl and triallyl cyanurate; polyfunctional vinyl compounds, preferably di- and trivinylbenzenes; and also triallyl phosphate and diallyl phthalate.

Preferred crosslinking monomers are allyl methacrylate, ethylene glycol dimethacrylate, diallyl phthalate and heterocyclic compounds which have at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinking monomers is preferably from 0.02 to 5% by weight, in particular from 0.05 to 2% by weight, based on the graft base E.2.

In the case of cyclic crosslinking monomers having at least 3 ethylenically unsaturated groups, it is advantageous to restrict the amount to below 1% by weight of the graft base E.2.

Examples of preferred “other” polymerizable, ethylenically unsaturated monomers which can serve alongside the acrylic esters, if appropriate, for preparation of the graft base E.2 are acrylonitrile, styrene, α-methylstyrene, acrylamides, vinyl C₁-C₆-alkyl ethers, methyl methacrylate, glycidyl methacrylate, butadiene. Acrylate rubbers preferred as graft base E.2 are emulsion polymers whose gel content is at least 60% by weight.

Other preferably suitable graft bases according to E.2 are silicone rubbers having sites active for grafting purposes, as described in DE-A 3 704 657 (=U.S. Pat. No. 4,859,740), DE-A 3 704 655 (=U.S. 4,861,831), DE-A 3 631 540 (=U.S. Pat. No. 4,806,593) and DE-A 3 631 539 (=U.S. Pat. No. 4,812,515).

Alongside elastomer modifiers based on graft polymers, it is also possible to use elastomer. modifiers not based on graft polymers but having glass transition temperatures <10° C., preferably <0° C., particularly preferably <−20° C. Among these can be, preferably, elastomers with block copolymer structure and also elastomers which can undergo thermoplastic melting, in particular EPM rubbers, EPDM rubbers and/or SEBS rubbers (EPM=ethylene-propylene copolymer, EPDM=ethylene-propylene-diene rubber and SEBS=styrene-ethene-butene-styrene copolymer).

The lubricants and/or mould-release agents to be used as component F) in one preferred embodiment of the compositions of the invention are preferably long-chain fatty acids, in particular stearic acid or behenic acid, salts thereof, in paricular Ca stearate or Zn stearate, and also amide derivatives or ester derivatives of these, in particular ethylenebisstearylamide, montan waxes, and also low-molecular-weight polyethylene waxes and low-molecular-weight polypropylene waxes. For the purposes of the present invention, montan waxes are mixtures of straight-chain, saturated carboxylic acids having chain lengths of from 28 to 32 carbon atoms. According to the invention it is particularly preferable to use lubricants and/or mould-release agents from the group of the esters or amides of saturated or unsaturated aliphatic carboxylic acids having from 8 to 40 carbon atoms with saturated aliphatic alcohols or amines having from 2 to 40 carbon atoms, or else metal salts of saturated or unsaturated aliphatic carboxylic acids having from 8 to 40 carbon atoms, where very particular preference is given to ethylenebisstearylamide, calcium stearate and/or ethylene glycol dimontanate, and in particular here to Licowax® E from Clariant, Muttenz, Basle, and in particular very particular preference is given to ethylenebisstearylamide.

In another preferred embodiment, the compositions can comprise, as component G), at least one further filler or reinforcing material which differs from component C).

It is also possible here to use a mixture of two or more different fillers and/or reinforcing materials, preferably based on talc, mica, silicate, quartz, titanium dioxide, wollastonite, kaolin, amorphous silicas, nano-scale minerals, particularly preferably inonmorillonite or nano-boehmite, magnesium carbonate, chalk, feldspar, barium sulphate, glass beads and/or fibrous fillers and/or reinforcing materials based on carbon fibres and/or glass fibres. It is preferable to use mineral particulate fillers based on talc, mica, silicate, quartz, titanium dioxide, wollastonite, kaolin, amorphous silicas, magnesium carbonate, chalk, feldspar, barium sulphate and/or glass fibres. It is particularly preferable to use mineral particulate fillers based on talc, wollastonite, kaolin and/or glass fibres, and it is very particularly preferable here to use glass fibres.

A further particular preference is also the use of acicular mineral fillers. According to the invention, acicular mineral fillers are a mineral filler with pronounced acicular character. A preferred example which may be mentioned is acicular wollastonites. The length: diameter ratio of the mineral is preferably from 2:1 to 35:1, particularly preferably from 3:1 to 19:1, most preferably from 4:1 to 12:1. The average particle size of the inventive acicular minerals is preferably smaller than 20 μm, particularly preferably smaller than 15 μm, with particular preference smaller than 10 μm, determined using a CILAS GRANULOMETER.

In one preferred embodiment, the filler and/or reinforcing material other than component C) can have been surface-modified, preferably with a coupling agent or coupling agent system, particularly preferably based on silane. However, the pretreatment is not essential. In particular when glass fibres are used, the following can also be used in addition to silanes: polymer dispersions, film-formers, branching agents and/or glass-fibre-processing aids.

The glass fibres to be used in accordance with the invention with very particular preference as component G) generally have a diameter of from 7 to 18 μm, preferably from 9 to 15 μm, and are added in the form of continuous-filament fibres or in the form of chopped or ground glass fibres. Fibrous ground glass fibres different from component C) can be obtained by subjecting continuous-filament fibres or chopped glass fibres to an additional grinding process, in particular in a bead mill. The said fibres can have been equipped with a suitable size system and with a coupling agent or coupling agent system, preferably based on silane.

Particularly preferred coupling agents based on silane for the pretreatment are silane compounds of the general formula (I)

(X—(CH₂)q)k-Si—(O'CrH2r+1)4-k (I)

in which
X is NH₂—, carboxy-, HO—or

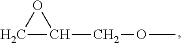

q is an integer from 2 to 10, preferably from 3 to 4,
r is an integer from I to 5, preferably from 1 to 2 and
k is an integer from I to 3, preferably 1.

Particularly preferred coupling agents are silane compounds from the group of aminopropyltrimethoxysilane, aminobutyltrimethoxysilane, aminopropyltriethoxysilane, amino-butyltriethoxysilane, and also the corresponding silanes which comprise, as substituent X, a glycidyl or carboxy group.

The amounts of the silane compounds provided to the fillers for surface coating are generally from 0.05 to 2% by weight, preferably from 0.25 to 1.5% by weight and in particular from 0.5 to 1% by weight, based on the mineral filler.

The d97 or d50 of the particulate fillers of component G), differing from component C), can by virtue of the processing to give the composition or to give the mouldings made of the composition, or within the moulding, be smaller than that of the fillers originally used. The length distributions of glass fibres of component G) can by virtue of the processing to give the composition or to give the mouldings made of the composition, or within the moulding, be shorter than those originally used. It is preferable to use, as component G), amounts, in each case based on the entire moulding composition, of from 1 to 30% by weight, particularly preferably from 2 to 15% by weight and very particularly preferably from 3 to 7% by weight, of fillers and reinforcing materials other than C).

The compositions of the invention can also comprise, as component H), further additives. For the purposes of the present invention, preferred additives are UV stabilizers, gamma-radiation stabilizers, hydrolysis stabilizers, heat stabilizers, antistatic agents, emulsifiers, nucleating agents, plasticizers, processing aids, impact modifiers, dyes and pigments. The additives can be used alone or in a mixture or in the form of masterbatches.

Preferred UV stabilizers used are substituted resorcinols, salicylates, benzotriazoles and benzophenones.

Preferred colorants used are inorganic pigments, in particular titanium dioxide, ultramarine blue, iron oxide, zinc sulphide or carbon black, and also organic pigments, preferably phthalocyanines, quinacridones, perylenes, and also dyes, preferably nigrosin and anthraquinones.

Preferred heat stabilizers used are sterically hindered phenols and/or phosphites, hydroquinones, aromatic secondary amines such as diphenylamines, substituted resorcinols, salicylates, benzotriazoles and benzophenones, and also various substituted members of the said groups or a mixture of these. It is particularly preferable to use sterically hindered phenols alone or in combination with phosphites, and it is very particularly preferable here to use N,N′-bis[3-(3′,5′-di-tert-butyl-4′-hydroxyphenyl)propionyl]hexamethylenediamine (e.g. Irganox® 1098 from BASF SE, Ludwigshafen, Germany).

Nucleating agents used preferably comprise sodium phenylphosphinate or calcium phenylphosphinate, aluminum oxide or silicon dioxide and very particularly preferably comprise talc, but this list is not exhaustive.

Preferred flow aids used are copolymers made of at least one a-olefin with at least one methacrylate or acrylate of an aliphatic alcohol. Particular preference is given here to copolymers in which the α-olefin is composed of ethene and/or propene and the methacrylate or acrylate comprises, as alcohol component, linear or branched alkyl groups having from 6 to 20 C atoms. ED Very particular preference is given to 2-ethylhexyl acrylate. Another feature of copolymers suitable according to the invention as flow aids, alongside constitution, is low molecular weight. Accordingly, materials particularly suitable for the compositions to be protected from thermal degradation according to the invention are copolymers which have an MFI of at least 100 g/10 min, preferably at least 150 g/10 min, particularly preferably at least 300 g/10 min, measured at 190° C. with a load of 2.16 kg. The MFI or melt flow index serves to characterize the flow of a melt of a thermoplastic and is covered by the standards ISO 1133 and ASTM D 1238. For the purposes of the present invention, the MFI, or all of the data relating to the MFI, are based on, or were uniformly measured or determined to, ISO 1133 at 190° C. with a test weight of 2.16 kg.

Plasticizers to be used with preference as component H) are dioctyl phthalate, dibenzyl phthalate, butyl benzyl phthalate, hydrocarbonoils and N-(n-butyl)benzene sulphonamide.

However, the present invention also provides products, preferably fibres, foils or mouldings, obtainable via injection moulding or extrusion from the compositions described according to the invention.

The present application also provides the use of the compositions of the invention in the injection moulding process, inclusive of the specialized processes GIT (gas injection technology), WIT (water injection technology) and PIT (projectile injection technology), in the extrusion process in the profile extrusion process, in the blowmoulding process, particularly preferably standard extrusion blowmoulding, the 3D extrusion blowmoulding process or suction blowmoulding process, with the aim of producing products of the invention therefrom.

Processes of the invention for producing products via extrusion or injection moulding operate at melt temperatures in the range from 230 to 330° C., preferably from 250 to 300° C., and where appropriate also at pressures of at most 2500 bar, preferably at pressures of at most 2000 bar, particularly preferably at pressures of at most 1500 bar and very particularly preferably at pressures of at most 750 bar.

A feature of the injection moulding process is that the raw material, preferably in granule form, is melted (plastified) in a heated cylindrical cavity and is injected in the form of injection melt under pressure within a temperature-controlled cavity. Once the melt has cooled (solidified), the injection moulding is demoulded.

Various stages are
1. plastification/melting
2. injection phase (charging procedure)
3. hold-pressure phase (to take account of thermal contraction during crystallization) and
4. demoulding

An injection moulding machine is composed of a clamping unit, the injection unit, the drive and the control system. The clamping unit has fixed and movable platens for the mould, an end platen, and also tie bars and drive for the movable mould platen. (Toggle assembly or hydraulic clamping unit.)

An injection unit encompasses the electrically heatable cylinder, the screwdrive (motor, gearbox) and the hydraulic system for displacing the screw and injection unit. The function of the injection unit consists in melting, metering and injecting the powder or the pellets and applying hold pressure thereto (to take account of contraction). The problem of reverse flow of the melt within the screw (leakage flow) is solved via non-return valves.

Within the injection mould, the inflowing melt is then separated and cooled, and the required component is thus manufactured. Two mould halves are always needed for this process. Various functional systems within the injection moulding process are as follows:
runner system
shaping inserts
venting
machine mounting and uptake of force
demoulding system and transmission of motion
temperature control.

The specialized injection moulding processes GIT (gas injection technology), WIT (water injection technology) and projectile injection technology (PIT) are specialized injection moulding processes for producing hollow workpieces. One difference from the standard injection moulding process consists in a specific operation towards the end of the phase where material is charged to the mould, or after a defined portion of the material has been charged to the injection mould. In the operation specific to the process, a device known as an injector is used to inject a process medium into the molten interior of the preform to form a cavity. In the case of GIT this is a gas—generally nitrogen—and it is water in the. In the case of PIT, a projectile is shot into the interior of the melt, thus forming a cavity.

In contrast to the injection moulding process, the extrusion process uses a continuously shaped strand of plastic, in this case a polyimide, in the extruder, where the extruder is a machine for producing thermoplastic mouldings. Various types of equipment are
single-screw extruders and twin-screw extruders and the respective subgroups
conventional single-screw extruders, conveying single-screw extruders,
contrarotating twin-screw extruders and corotating twin-screw extruders.

For the purposes of the present invention, profiles are components which have an identical cross section over their entire length. They can be produced by the profile extrusion process. The fundamental steps of the profile extrusion process are:
1. plastification and provision of the thermoplastic melt in an extruder,
2. extrusion of the thermoplastic melt strand through a calibrator shell which has the cross section of the profile to be extruded,
3. cooling of the extruded profile on a calibrating table,
4. onward transport of the profile, using a take-off behind the calibrating table,
5. cutting of the continuous profile to length in a cutter system, and
6. collection of the cut-to-length profiles on a collection table.

A description of profile extrusion of nylon-6 and nylon-6,6 is given in Kunststoff-Handbuch [Plastics Handbook] 3/4, Polyamide [Polyamides], Carl Hanser Verlag, Munich 1998, pp. 374-384.

For the purposes of the present invention, blowmoulding processes are preferably standard extrusion blowmoulding, 3D extrusion blowmoulding, suction blowmoulding processes and sequential coextrusion.

According to Thielen, Hartwig, Gust, “Blasformen von Kunststoffhohlkörpern” [Blowmoulding of hollow plastics], Carl Hanser Verlag, Munich 2006, pp. 15 to 17, the fundamental steps of the standard extrusion blowmoulding process are:
1. plastification and provision of the thermoplastic melt in an extruder,
2. deflection of the melt to flow vertically downwards and shaping of a tubular melt “parison”,
3. using a mould, the blow mould, generally composed of two half shells, to enclose the parison, freely suspended below the head,
4. insertion of a blowing mandrel or of one or more blowing pin(s),
5. blowing of the plastic parison onto the cooled wall of the blow mould, where the plastic cools and hardens, and assumes the final shape of the moulded part,
6. opening of the mould and demoulding of the blow-moulded part,
7. removal of the pinched-off “flash” waste at both ends of the blow-moulded part.

Other downstream operations can follow.

Standard extrusion blowmoulding can also be used to produce components with complex geometry and multiaxial curvature. However, the resultant products then comprise a high proportion of excess, pinched-off material and have large regions with a pinch-off weld.

To avoid pinch-off welds and to reduce materials usage, 3D extrusion blowmoulding, also termed 3D blowmoulding, therefore uses specific devices to deform and manipulate a parison with diameter adapted to the cross section of the item, and then introduces this directly into the cavity of the blow mould. The extent of the remaining pinch-off edge is therefore reduced to a minimum at the ends of the item (Thielen, Hartwig, Gust, “Blasformen von Kunststoffhohlkörpern” [Blowmoulding of hollow plastics], Carl Hanser Verlag, Munich 2006, pp. 117-122).

In suction blowmoulding processes, the parison is conveyed directly from the tubular die head into the closed blow mould and “sucked” through the blow mould by way of an air stream. Once the lower end of the parison emerges from the blow mould, clamping elements are used to pinch off the upper and lower ends of the parison, and the blowing and cooling procedures then follow (Thielen, Hartwig, Gust, “Blasformen von Kunststoffhohlkörpern” [Blowmoulding of hollow plastics], Carl Hanser Verlag, Munich 2006, p. 123).

The products of the invention are used in the motor vehicle industry, electrical industry, electronics industry, telecommunications industry, or computer industry, or in sport, in medicine, in households, in the construction industry or in the entertainment industry.

It will be understood that the specification and examples are illustrative but not imitative of the present invention and that other embodiments within the spirit and scope of the invention will suggest themselves to those skilled in the art.

### EXAMPLES

In order to demonstrate the flame retardancy improvements described according to the invention, compounding was first used to produce appropriate plastics compositions. To this end, the individual components were mixed in a twin-screw extruder (ZSK 25 Compounder from Coperion Werner & Pfleiderer (Stuttgart, Germany)) at temperatures from 250 to 310° C., extruded in the form of a strand, cooled until pelletizable, and pelletized. After drying (generally 2 days at 70° C. in a vacuum oven), the pellets were processed at temperatures of from 250 to 300° C. to give standard test specimens for the respective tests.

Firstly, the flame retardancy of the compositions was determined by the UL 94V method (Underwriters Laboratories Inc. Standard of Safety “Test for Flammability of Plastic Materials for Parts in Devices and Appliances”, p. 14 to p. 18, Northbrook 1998). The thickness of the standard test specimens was 0.75 mm.

Glow-wire resistance was determined on the basis of the glow-wire test GWFI (glow-wire flammability index) to IEC 60695-2-12 on discs of thickness 0.75 and/or 1.5 mm.

Particle sizes were determined on the ground glass particles by using a laser-optics method (“Eye Tech”) from Ankersmid Ltd, Oosterhout, Netherlands, in an “ACM-104 Liquid Flow (4×4 mm)” cell. The measurement took about 900 sec. The evaluation is based on the surface area of the glass particles.

The Experiments Used:
Component A: (Durethan® B26, Lanxess Germany GmbH, Leverkusen, Germany)
Component B: Melamine cyanurate, (Melapur® MC25, from BASF, Ludwigshafen, Germany)

Component C: MF7900 from Lanxess Germany GmbH, Leverkusen, Germany. [A non-fibrous and unfoamed ground glass based on E glass comprising about 0.1% by weight of triethoxy(3-aminopropyl)silane size C′) with d90 54 μm, d50 14 μm, d10 2.4 μm and average particle size 21 μm, based in each case on the surface area of the particles.]

Component E: impact modifier (Paraloid® EXL-2300, Dow Corning Corporation, Midland Mich., USA)

Component F: Mould-release agent (N,N′-ethylenebisstearylamide or Licoax® E from Clariant GmbH, Muttenz, Switzerland)
Component G1: Chopped glass fibre CS 7928, sized, Lanxess Germany GmbH, Leverkusen, Germany)
Component G2: Ground chopped glass fibre MF 7982, sized, Lanxess Germany GmbH, Leverkusen, Germany)
Component G3: Glass beads (aminoalkyltrialkoxysilane size 0.2% by weight) with typical particle size in the region of 35 μm (Potters Spheriglas® 3000 CP 0302 from Potters Industries Inc., Valley Forge, USA)
Component G4: Granulated expanded glass (Poraver® 0.04, Bennert Poraver GmbH, Postbauer Heng, Germany)
Component G5: Mineral Talc powder (Luzenac® A6OH, Luzenac Europe SAS, Toulouse, France)
Component G6: Mineral Talc powder (Luzenac® 1445, Luzenac Europe SAS, Toulouse, France)
Component G7: Mineral wollastonite (Nyglos M3, Nyco Minerals, New York, USA)
Component H1: Heat stabilizer (Irganox® 1098, BASF, Ludwigshafen, Germany)

The nature and amount of component F is the same in each of the inventive examples and comparative examples

TABLE 1

| | | 1 | C1 | C2 | C3 | C4 | 2 | C5 | 3 | C6 |
|---|---|---|---|---|---|---|---|---|---|---|
| A | [%] | 61.2 | 61.2 | 61.2 | 61.2 | 61.2 | 71.7 | 71.7 | 61.2 | 61.2 |
| C | [%] | 30 | | | | | 20 | | 28 | |
| G1 | [%] | | 30 | | | | | | | 28 |
| G2 | [%] | | | 30 | | | | | 2 | 2 |
| G4 | [%] | | | | 30 | | | 20 | | |
| G5 | [%] | | | | | 30 | | | | |
| B | [%] | 8 | 8 | 8 | 8 | 8 | 7.5 | 7.5 | 8 | 8 |
| F | [%] | 0.3 | 0.3 | 0.3 | 0.3 | 0.3 | 0.3 | 0.3 | 0.3 | 0.3 |
| H1 | [%] | 0.5 | 0.5 | 0.5 | 0.5 | 0.5 | 0.5 | 0.5 | 0.5 | 0.5 |
| GWFI | ° C. | 960 | <960 | 960 | <960 | <900 | — | — | 960 | <960 |
| (0.75 mm) | | | | | | | | | | |
| UL 94 | Class | V-0 | V-2 | V-2 | V-2 | V-2 | V-0 | V-2 | V-0 | V-2 |
| (0.75 mm) | | | | | | | | | | |

Data for components in % by weight, based on entire moulding composition

The examples in table 1 show that when the formulations 1, 2. and 3 of the invention, which comprise not only component A) but also melamine cyanurate as component B) and component C) sized with C′) are compared with comparative examples C1 to C6, i.e. compositions which do not comprise the unfoamed, non-fibrous ground glass to be used according to the invention, they exhibit marked advantages in terms of fire performance in the form of V-0 classification.

TABLE 2

| | | 4 | C7 | C8 | C9 |
|---|---|---|---|---|---|
| A | [%] | 70.2 | 70.2 | 70.2 | 70.2 |
| B | [%] | 4 | 4 | 4 | 4 |
| C | [%] | 25 | | | |
| G2 | [%] | | 25 | | |
| G6 | [%] | | | 25 | |
| G7 | [%] | | | | 25 |
| F | [%] | 0.3 | 0.3 | 0.3 | 0.3 |
| H1 | [%] | 0.5 | 0.5 | 0.5 | 0.5 |
| GWFI (0.75 mm) | [° C.] | 960 | <960 | <960 | <960 |

Data for components in % by weight, based on entire moulding composition

The examples in table 2 show that when formulation 4 of the invention, which comprises not only component A) but also melamine cyanurate as component B) and component C) sized with C), is compared with comparative examples C7 to C9, i.e. compositions which do not comprise the unfoamed, non-fibrous ground glass to be used according to the invention, it exhibits marked advantages in terms of fire performance in the form of GWFI classification of 960° C., even when the concentration of flame retardant (component B) is low.

What is claimed is:

1. A composition comprising
A) from 5 to 95 by weight of a thermoplastic polyamide,
B) from 0.01 to 40% by weight of melamine cyanurate and
C) from 5 to 80% by weight of a non-fibrous and unfoamed ground glass with d90 from 10 to 200 μm, wherein the non-fibrous and unfoamed ground glass has been sized with at least one aminoalkyltrialkoxysilane.

2. The composition according to claim 1, wherein non-fibrous and unfoamed ground glass has been sized at least one aminoalkyltrialkoxysilane.

3. The composition according to claim 1 wherein the aminoalkyltrialkoxysilane is used in amounts of from 0.01% by weight to 1.5% by weight, based on the amount of the non-fibrous and unfoamed ground glass.

4. The composition according to claim 1, further comprising:
D) from 0.01 to 60% by weight of at least one halogen-containing flame retardant or of at least one halogen-free flame retardant different from component B).

5. The composition according to claim 1, comprising:
E) from 0.01 to 50% by weight of at least one elastomer modifier.

7. The composition according to claim 1, further comprising:
F) from 0.01 to 5% by weight of at least one lubricant and/or mould-release agent.

8. The composition according to claim 1, further comprising
G) from 0.01 to 50% by weight of at least one filler other than component C).

9. The composition according to claim 1, further comprising
H) from 0.01 to 20% by weight of at least one further additive.

10. The composition according to claim 1, further comprising at least one further thermoplastic polymer.

11. The composition according to claim 10 wherein the further thermoplastic polymer is at least one other polyamide.

12. The composition according to claim 1, wherein the non-fibrous and unfoamed ground glass is of non-cylindrical particulate shape with diameter: thickness ratio less than 5.

13. The composition according to claim 1, wherein the unfoamed and non-fibrous ground glass exhibits no density reduction due to any possible gas inclusions.

14. The composition according to claim 1, wherein the unfoamed and non-fibrous ground glass does not exhibit the geometry which is typical of fibrous glass and which involves a cylindrical or oval cross section with a length: diameter ratio (L/D ratio) greater than 5.

15. The composition according to claim 1, wherein the non-fibrous and unfoamed ground glass is based on soda-lime glass or E glass.

16. The composition according to claim 1, wherein the non-fibrous and unfoamed ground glass comprises types of glass in which the content of K₂O, based on all of the components of the glass, is smaller than or equal to 2% by weight.

17. The composition according to claim 1, wherein the thermoplastic polyamide comprises PA 6 or PA 66.

18. The composition according to claim 1, wherein the d10 of the non-fibrous and unfoamed ground glass is from 0.6 to 10 μm.

19. The composition according to claim 18, wherein the d50 of the non-fibrous and unfoamed ground glass is from 3 to 50 μm.

20. A product obtained from the compositions according to claim 1 via injection moulding or extrusion.

21. The product according to claim 20, wherein such product is a fibre, foil or moulding.
